(19) United States
(12) Patent Application Publication
(10) Pub. No.: US 2025/0391088 A1
(43) Pub. Date: Dec. 25, 2025

(54) OPTIMIZING COMPUTATIONAL GRAPHS FOR VISUAL SCRIPTING AND DISTRIBUTED CONTENT CREATION

(71) Applicant: NVIDIA CORPORATION, Santa Clara, CA (US)

(72) Inventors: Rémi François QUENIN, Montreal (CA); Sean Joseph Thompson, Chambly (CA)

(21) Appl. No.: 18/747,625

(22) Filed: Jun. 19, 2024

(51) Int. Cl. G06T 15/00; G06F 16/901

(52) U.S. Cl. CPC G06T 15/005; G06F 16/9024

(57) ABSTRACT

In various examples, data required by some nodes of a visual scripting computational graph may be defined by the attributes of the target prims it is operating on, and that computational graph may be organized in memory by querying this target prim data to identify a count of matching prims and locations of the target prim data, allocating memory for the graph based on the matching prim count, reading the prim data from the identified locations instead of copying it into memory, and writing the results of node operations into the allocated memory. The results of the last node operation may be written directly back to the storage locations of the target prim data. As such, the present techniques may be used to avoid copying prim data to and/or from allocated memory for the graph.

### BACKGROUND

Visual scripting platforms typically provide a type of programming interface that allows users to create logic and define behaviors within a software application using a visual environment rather than traditional text-based code. Visual scripting is often used in content creation—such as for game development, multimedia applications, and other interactive programs—to make the process of scripting accessible to people who may not have a formal background in programming. Typically, visual scripting platforms accept some type of visual user input to create and manipulate a computational (or compute) graph, where each node represents a discrete user-defined operation or function, and connections between nodes depict the flow of data. This visual interface facilitates drag-and-drop programming without requiring users to write traditional code. As users construct their graph, the platforms dynamically generate the underlying code for the computational graph. The computational graph may then be used by an execution engine, which interprets and processes the graph to perform the specified operations in the correct order. Visual scripting has been used in various fields such as graphic design and three-dimensional (3D) modeling (e.g., to visually manipulate geometric primitives forming complex scenes and objects), animation (e.g., to visually define and control a sequence of movements and transformations of geometric primitives), and game development (e.g., to visually script game functions like animations, character movements, collision detection, and scoring systems).

Conventionally, applying a computational graph (e.g., that defines an animated behavior) during a presentation/visualization to an arbitrary set of geometric primitives (or prims) involves a gather phase to copy the relevant prim data to be manipulated (e.g., position, scale, etc.) from the set of prims for processing by the graph, followed by the processing of the prim data according to the graph, and then a scatter phase to propagate the updated data computed by the graph back to the set of prims. In many instances, the time and resources spent transferring data into and out of the computational nodes in the graph are greater than the time and resources used to process the data within the graph. As a result, in many cases, the overhead of data movement exceeds the data processing time, resulting in an inefficient use of computational resources and increased latency and energy consumption. Furthermore, the latency can undermine many real-time animations or simulations. These drawbacks are compounded in applications that operate on large numbers of prims and/or those that run large numbers of computational graphs, such as large scale simulations and rendering tasks in industries such as animation, film, and virtual reality, where scenes can be highly detailed and include millions of individual prims. However, users of visual scripting platforms typically lack the experience and sophistication in programming required to address these challenges. As such, there is a need for improved techniques for building and executing computational graphs, particularly in visual scripting platforms.

### SUMMARY

Embodiments of the present disclosure relate to optimization of computational graph data for visual scripting platforms. For example, systems and methods are disclosed that use visual scripting to define (e.g., generate or modify) a scene and/or a compute graph that defines behaviors of target primitives in the scene, and execute the compute graph to update the primitive behaviors without copying the target primitive data into allocated memory for the compute graph.

In contrast to conventional systems, such as those described above, target prim data for a node of a computational graph may be identified using an attribute of the node, and the computational graph may be organized in memory by querying the target prim data to identify a count of matching prims and locations of the target prim data, allocating memory for the graph based on the matching prim count, reading the prim data from the identified locations instead of copying it into memory, and writing the results of node operations into the allocated memory. The results of the last node operation may be written directly back to the storage locations of the target prim data. As such, the present techniques may be used to avoid copying prim data to and/or from allocated memory for the graph.

### BRIEF DESCRIPTION OF THE DRAWINGS

The present systems and methods for optimization of computational graph data for visual scripting platforms are described in detail below with reference to the attached drawing figures, wherein:

FIG. 1 is an illustration of an example visual scripting system, in accordance with some embodiments of the present disclosure;

FIG. 2 is an illustration of target prims for a computational graph, in accordance with some embodiments of the present disclosure;

FIG. 3 is an illustration of an example type resolution, in accordance with some embodiments of the present disclosure;

FIG. 4 is an illustration of an example mapping between input data buckets and a graph bucket, in accordance with some embodiments of the present disclosure;

FIG. 5 is an illustration of an example technique for executing a graph node using different tasks for different target prim data buckets, in accordance with some embodiments of the present disclosure;

FIG. 6 is a flow diagram illustrating a method for reserving memory for one or more computational graphs, in accordance with some embodiments of the present disclosure;

FIG. 7 is a flow diagram illustrating a method for sizing allocated memory for one or more computational graphs, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed relating to optimizations in the use of computational graph data for visual scripting platforms. For example, target prim(itive) data for a node of a computational graph may be identified using an attribute of the node, and the computational graph may be organized in memory by querying the target prim data to identify a count of matching prims and locations of the target prim data, allocating memory for the graph based on the matching prim count, reading the prim data from the identified locations instead of copying it into memory, and writing the results of node operations into the allocated memory. The results of the last node operation may be written directly back to the storage locations of the target prim data. As such, the present techniques may be used to avoid copying prim data to and/or from allocated memory for the graph.

In visual scripting platforms, prims may be positioned and oriented within a scene—such as a viewport or scene where 3D models are assembled, animated, and rendered; a game world or level where a game's objects, characters, and interactive elements exist; a 3D representation of an immersive environment such as a virtual space in virtual reality (VR) or a real-world environment augmented by digital objects in augmented reality (AR); a canvas or element where 3D content (including content from content creation platforms connected via plug ins or APIs) may be rendered for interaction; etc. Conventionally, applying a behavior to a set of arbitrary prims in a scene is an authoring operation in the visual scripting platform: the user must explicitly add the behavior to the prim(s) of interest using a visual interface of the visual scripting platform (e.g., by dragging and connecting functional nodes from a toolbox into a visual scripting workspace and configuring them to interact with selected prims). For example, if a user wanted several objects to glow or react to user input, they would explicitly add a glowing behavior or interactive behavior to these objects.

By contrast, in some embodiments, the presence of the data to be modified on the prim itself (e.g., the existence of an emission or glow attribute for a glowing behavior) may be used to conclude that the behavior needs to operate on that data. For example, prims may be organized in memory using a structure of arrays (SoA) configuration, where prim data may be stored in data buckets that vectorize prim attribute data for prims of a corresponding type (e.g., a cone bucket, a sphere bucket) and/or for prims with common combinations of attributes or other components shared by a common type of prims (e.g., a first cube bucket for cubes that have a first combination of attributes and a second cube bucket for cubes that have a second combination of attributes).

As such, in some embodiments, in order to apply a behavior to a set of target prims, the target prims may be specified by attribute, property, or other component (e.g., as a node attribute for a node representing an operation that should be performed on the target prims). Accordingly, the target prims may be identified by scanning the data buckets against the specified attribute, property, or other component. For example, a user may specify an operation to be performed on all prims in a scene that have a scale component, and the data buckets that store the prims in the scene may be scanned to identify which buckets have a scale component and their depth (e.g., a count of the prims in the buckets). As such, a user may indirectly specify an arbitrary number of target prims simply by designating the attribute, property, or other component of the prims on which the behavior should be applied, instead of having to manually identify each target prim in the scene.

In some embodiments, the computational graph may be organized in memory based on the way the target prim data is organized in memory. For example, the target prim data may be queried to identify the data buckets and/or target prims that store the target data (e.g., via a list of pointers) and a count of the target prims that match the query, and the count may be used to allocate memory (e.g., a graph data bucket) for the graph. Depending on the node operations in a graph and/or the implementation, some nodes may represent operations that can be performed on different types of data (e.g., integer, float). As such, to resolve the data type for the entire chain of nodes in the graph, the target prim data may be queried to identify their data type, the data type may be propagated through the graph in a first pass, and memory for the results of the graph computations on the resolved data types may be allocated in a second pass. To execute the graph, a set of initial node operations in a branch of a graph (source node(s)) may read the target prim data instead of copying it into the graph bucket, writing the results of each node operation into the allocated memory, and writing the results of a final set of node operations in a branch of the graph (destination node(s)) directly to the locations where the target prim data are stored instead of writing to and copying from the graph bucket. In some embodiments, during graph execution, the query may be rerun periodically (e.g., at a designated frame rate), and if the query results change (e.g., because the user changed a mapped attribute from a float to an integer, added or removed prims from the scene, etc.), memory may be reallocated in response to the updated query results. As such, instead of copying the target prim data to match the organization of the graph data, the internal organization of the graph (e.g., the depth and ordering of the graph bucket) may be organized to match the organization of the prim data in memory.

As such, by reorganizing the graph memory layout, prim data may be accessed efficiently and directly, without the need to copy prim data between memory locations and without impacting the cost of the graph evaluation. If the prim data is vectorized, the graph computation may take advantage of that layout by allowing source and destination computation nodes to directly access that data in that form. Even if this source and destination data is scattered across different buffers, the internal data of the graph should remain compact and vectorized, facilitating hardware-efficient computation within the graph. As a result, the present techniques improve the computational efficiency, reduce latency, and/or reduce energy consumption over prior techniques.

Furthermore, the present techniques dramatically reduce the visual scripting effort required by conventional techniques, as the user no longer needs to manually specify each target prim. In some embodiments, an input specifying a target prim attribute, prim property, or other prim component may be converted into a query (e.g., implemented using a single line of script), which may be used to gather all targets and apply the graph to an arbitrary number of prims (e.g., tens of thousands). The present techniques achieve unparalleled performance for a visual script when applied on a set of fully vectorized data, substantially improving computational speed compared to the conventional gather/scatter technique. Furthermore, the additional cost of adding new prims (that exhibit the queried data and are consequently enrolled in the graph) to the behavior computation represented by the graph is almost negligible, an effect that has not been matched in any known solutions within the visual scripting field. As such, a visual script may be automatically applied to a set of prims based on the data they expose.

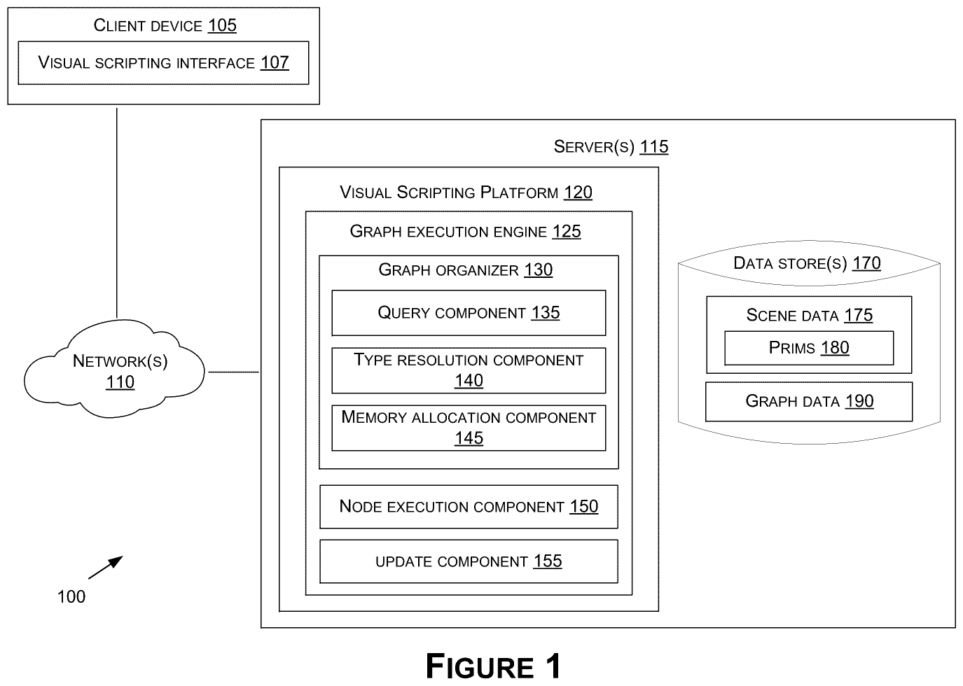

With reference to FIG. 1, FIG. 1 is an example visual scripting system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

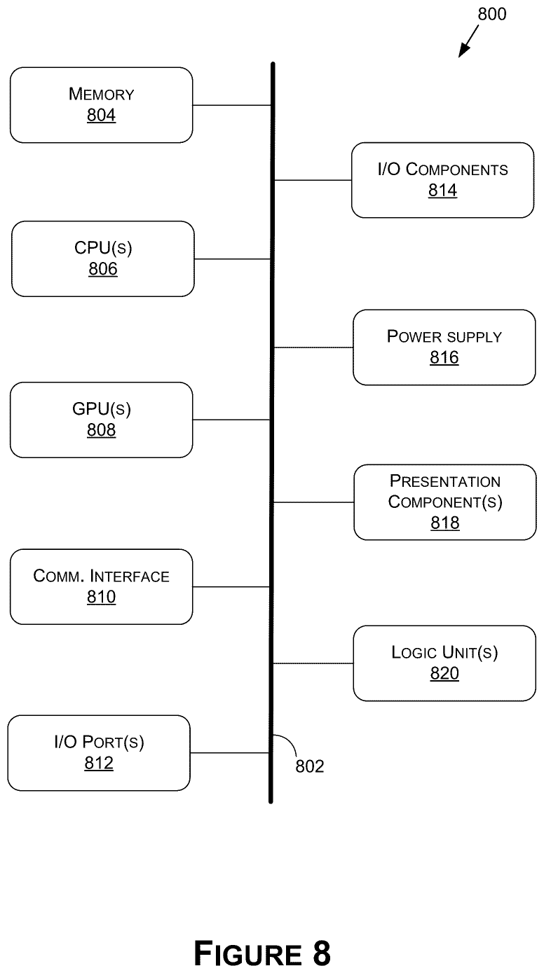

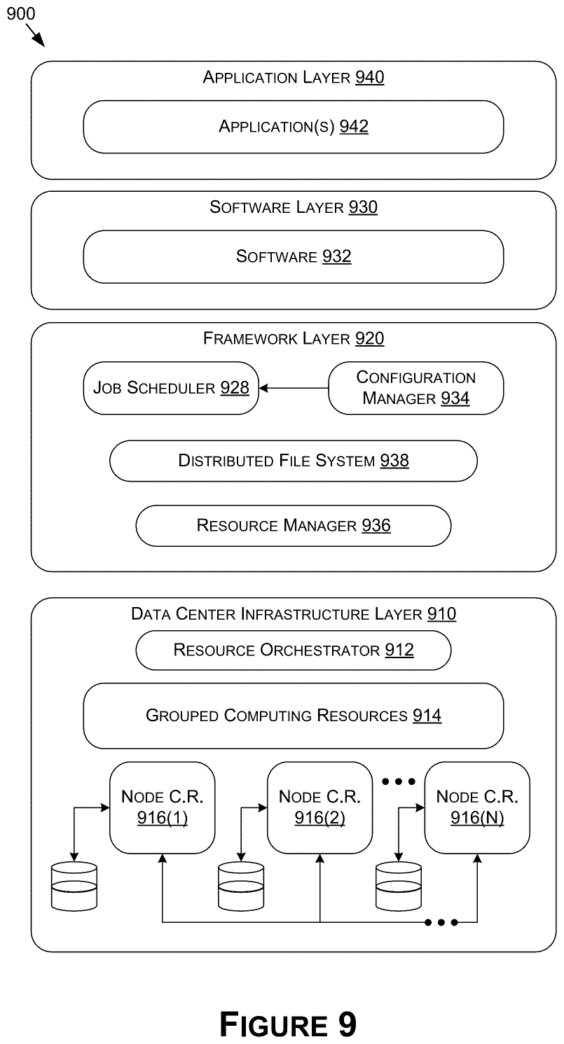

In the embodiment illustrated in FIG. 1, the visual scripting system 100 includes a client device 105 comprising a visual scripting interface 107, and one or more server(s) 115 comprising a visual scripting platform 120 and one or more data store(s) 170. Generally, the client device 105 and/or the server(s) 115 may each be any kind of computing device, such as the computing device 800 of FIG. 8. The data store(s) 170 may be any suitable repository for storing and managing data, such as in-memory storage, external databases, distributed storage, and/or otherwise. The components of the visual scripting system 100 may communicate with each other via a network 110, which may include any number and type of networks, such as those described with respect to FIGS. 8 and 9 below.

In the example illustrated in FIG. 1, the visual scripting interface 107 on the client device 105 and/or the visual scripting platform 120 on the server(s) 115 constitute and/or coordinate to execute functionality of a visual scripting application, such as NVIDIA's OmniGraph. Depending on the implementation, the visual scripting application may execute in various environments. FIG. 1 illustrates an example in which components of the visual scripting application run on the client device 105 and the server(s) 115, but this need not be the case. Generally, the visual scripting application may take the form of stand-alone application (e.g., run on a desktop computer, laptop, mobile device, etc.), a mobile app (e.g., run on a smartphone or tablet), a web-based application (e.g., run within a web browser), and/or otherwise. In some embodiments, the visual scripting application may rely on the hardware (e.g., storage and/or processing) resources of the client device 105, one or more other client devices, the server(s) 115, and/or otherwise.

At a high level, the visual scripting application may include a visual interface (e.g., the visual scripting interface 107) that provides a workspace in which a user may arrange primitives in a scene in one part of the interface, and a compute graph specifying behaviors to apply to the primitives in another part of the interface. Continuing with the example illustrated in FIG. 1, the visual scripting interface 107 may send a corresponding representation of the arranged scene and/or compute graph to the visual scripting platform 120, which may store a representation of the scene (e.g., as scene data 175 representing an arrangement of prims 180) and a representation of the compute graph (e.g., as graph data 190) in the data store(s) 170. The visual scripting platform 120 may include a code generator or graph compiler that translates visual elements and user interactions from the visual scripting interface 107 into executable code that a graph execution engine 125 can execute, and the visual scripting platform 120 may include the executable code in the graph data 190. When the user triggers execution of the compute graph (e.g., via user input received by the visual scripting interface 107, such as clicking a run or execute button), the graph execution engine 125 may access and execute the code stored in the graph data 190.

More specifically, the visual scripting interface 107 may provide various tools that accept user input to arrange a scene composed of primitives and defining behaviors for these primitives using a compute graph. For example, to arrange the scene, a user may use corresponding tools to select and arrange primitive shapes (e.g., cubes, spheres, planes, etc.) on a workspace or canvas within the interface. Generally, the visual scripting interface 107 may provide any known tool to facilitate arranging the scene, such as tools that accept user input positioning, scaling, and rotating primitives (e.g., through direct manipulation, by entering values into property panels, etc.), tools for grouping, aligning, and/or layering primitives to build more complex structures, and/or otherwise. The visual scripting interface 107 may transmit a representation of the primitives in the scene, their arrangement, and their attributes to the visual scripting platform 120, which may store or otherwise identify the scene data 175 and the prims 180 in the data store(s) 170 (e.g., using a data format like Universal Scene Description (USD) to structure and store the elements within the scene). As the user adds and configures primitives, the visual scripting platform 120 may assign unique identifiers to each primitive, and may store the attribute data for each primitive (e.g., position, scale, rotation, color, other custom properties, etc.), for example, as part of the primitive's metadata. Changes made through the visual scripting interface 107 (e.g., moving a primitive or adjusting its attributes) may be propagated by the visual scripting interface 107 to the prims 180 in the data store(s) 170 to synchronize the visual representation of the prims 180 and their underlying data.

In some implementations, the visual scripting application may support scenes that arrange significant numbers of primitives, such as those used in large-scale simulations, complex animations, detailed 3D modeling projects, and/or expansive game environments. By way of nonlimiting example, a driving or city simulation might involve thousands or hundreds of thousands of building blocks, vehicles, and pedestrians, each represented as a corresponding primitive. Large scale simulations and rendering tasks in industries such as animation, film, and virtual reality may include highly detailed scenes with millions of individual prims. To efficiently manage and organize the prims 180, the visual scripting platform 120 may separate and store the prims 180 according to their attribute data in corresponding data buckets (e.g., histogram bins) in the data store(s) 170 using a structure of arrays (SoA) configuration, where the data buckets vectorize the attribute data in contiguous memory locations for prims of a corresponding type (e.g., a cone bucket, a sphere bucket) and/or for prims with common combinations of attributes or other components shared by a common type of prims (e.g., a first cube bucket for cubes that have a first combination of attributes and a second cube bucket for cubes that have a second combination of attributes). For example, if all the cones in the scene have properties like position, color, and size, a cone bucket may store all the positions of the cones together, all the colors of the cones together, and all sizes of the cones together.

Once the scene is arranged, the user may define behaviors for the primitives by constructing a compute graph. For example, the visual scripting interface 107 may provide various tools that accept user input arranging (e.g., dragging and dropping) functional graph nodes onto the workspace and connecting them to form a graph. Each graph node may represent an operation or behavior, such as moving a primitive, changing its color, or applying a glow effect, to name a few examples. By linking these nodes, the user may establish a flow of data and a sequence of operations. For example, to create a glowing effect on a sphere, the user might connect a node that sets the sphere's emission property to a value that makes it glow. Other nodes may be added to modify this behavior in response to user input and/or environmental changes, such as increasing the glow intensity when the sphere is clicked in the scene.

In some embodiments, a user may create a compute graph that controls the movement and color change of a single primitive. Additionally or alternatively, the visual scripting interface 107 may accept input designating the creation of multiple instances of a compute graph to apply the same behavior to multiple primitives in the scene. In some embodiments, the graph may be manually assigned to one or more target primitives. Additionally or alternatively, the target prims for the behavior implemented by a compute graph may be identified by the target prim attribute, property, or other component transformed by the behavior. For example, to specify that a compute graph should operate on all of the prims 180 that have a scale attribute, the visual scripting interface 107 may accept input identifying and associating the scale attribute (e.g., by name or other identifier) with the compute graph. Depending on the implementation, this user-specified target primitive attribute may be designated in various ways. For example, the visual scripting interface 107 may visually represent the compute graph and accept some input associating one of the nodes in the graph with a target primitive attribute operated on by the node (e.g., a click or tap selecting or interacting with the node, a menu of options, and/or an selected option to map the node to a target prim attribute; designating the target prim attribute for a node by typing in the name or other identifier of the target prim attribute into a text field, selecting the name of the target prim attribute from a drop-down menu, designating the target prim attribute via an application programming interface, etc.). The visual scripting interface 107 and/or the visual scripting platform 120 may store the specified identifier of the target prim attribute as part of the graph data 190 for the compute graph (e.g., in a node attribute of the compute graph that identifies the input data for the node). These are just a few examples, and other variations are contemplated within the scope of the present disclosure.

In some embodiments, specifying the target prim attribute for a graph node (e.g., in a node attribute of the compute graph that identifies the input data for the node) provides an alternative to the conventional technique in which prim data must be first imported into the compute graph via an import node that implements a copy operation. For example, and as described in more detail below, the graph execution engine 125 may execute a query that reads the identifier of the target prim attribute (e.g., from a corresponding node attribute of a graph node that specifies a transformation of the attribute data of the target prim attribute), queries the prims 180 to identify the relevant target prims and their locations in storage, and reads them instead of importing them into allocated storage (e.g., a graph data bucket, also referred to as a graph bucket) for the graph data 190 of the graph. Generally, any graph node in the compute graph that operates on prim data may be associated with one or more corresponding target prim attributes (e.g., by specifying one or more corresponding identifiers in corresponding node attributes that that identify input or output data for the node).

In some embodiments, additionally or alternatively to associating target prims with individual compute nodes, the visual scripting interface 107 may visually represent a consolidated version of a compute graph that identifies all target prim and/or target prim attributes designated as inputs and/or outputs for a plurality of compute nodes (e.g., all nodes, a selected subset of nodes) of a compute graph. For example, the compute graph may be visually represented as a compound node that represents the entirety of the code of the compute graph, and that accepts input specifying what target prim attributes the graph inputs (and corresponding transformed outputs) should map to. This is meant simply as an example, and other ways of specifying target prim attributes for compute nodes and compute graphs are contemplated within the scope of the present disclosure.

As such, the visual scripting interface 107 may accept input arranging a compute graph, and the visual scripting interface 107 and/or the visual scripting platform 120 may store the compute graph in the graph data 190 in the data store(s) 170 (e.g., in some structured format that represents each node in the compute graph; its connections; node attributes such as those identifying or referencing the data the node receives, the functionality of the node, and/or the data the node produces; associated executable code, etc.). For example, a code generator or graph compiler in the visual scripting platform 120 may be triggered (e.g., triggered via user input received by the visual scripting interface 107 such as input clicking or tapping on a compile or run button; triggered automatically such as when changes are detected in the compute graph, etc.) and may use any known technique to translate visual elements and user interactions from the visual scripting interface 107 into executable code, which the visual scripting platform 120 may include or reference in the graph data in the data store(s) 170.

As such, the graph execution engine 125 may be triggered (e.g., by the visual scripting interface 107 in response to user input triggering execution of one or more designated compute graphs) and may allocate the necessary memory, manage data flows, and execute the compiled code of the compute graph represented by the graph data 190. In the example illustrated in FIG. 1, the graph execution engine 125 includes a graph organizer 130 that allocates memory for the designated compute graph(s), a node execution component 150 that executes the nodes of the designated compute graph(s), and an update component 155 that monitors for updates and triggers a memory reallocation when needed.

In the embodiment illustrated in FIG. 1, the graph organizer 130 includes a query component 135 that queries the prims 180 to identify the data buckets (bins) and/or target prims in the data store(s) 170 that store the target data designated by the compute graph(s), a type resolution component 140 that resolves the data type for the chain of nodes in the compute graph(s), and a memory allocation component 145 that allocates memory in the data store(s) 170 (e.g., a graph bucket for one or more instances of a designated compute graph) for storing computational results generated by executing the compute graph(s) and/or for storing the executable code of the compute graph(s) (e.g., which may be collectively represented by the graph data 190).

At a high level, the query component 135 may identify the target prims and/or prim attribute data for a designated compute graph by querying the prims 180 for a target prim attribute designated and/or otherwise required by the compute graph. For example, each node in the compute graph may include a node attribute or other property that identifies the target prim attribute data (or a subset thereof) for that node using an identifier for the target prim attribute data (e.g., the name of the prim attribute). Generally, a set of node operation(s) may require (e.g., operation on) a certain type of target prim attribute data (e.g., a graph that moves or rotates prims may operate on transform-related attributes), and a user may want to apply those node operation(s) only to a certain type of primitive (e.g., spheres). As such, the node attribute or other property that identifies target prim attribute data may additionally or alternatively be used to limit a superset of target prim attribute data otherwise required by the node operation(s) to a subset that matches a designated prim attribute. As such, the query component 135 may traverse the nodes of the compute graph, identify nodes that reference target prim data, query the prims 180 to identify the data buckets where prims that include the designated prim attribute (or the union of designated and required prim attributes) are stored, and identify a count of the matching prims. For example, the prims 180 may be represented using one or more lists, tables, trees, and/or other data structure(s) (e.g., a scene graph, prim manifest, etc.) identifying which prims are part of the scene, references (e.g., pointers) to corresponding data buckets where those prims are stored in the data store(s) 170 (and/or references to corresponding prims), a representation of which data buckets contain which data attributes, a count of the prims in each data bucket, etc. As such, the query component 135 may traverse the data structure(s) to lookup which data buckets contain a designated prim attribute, lookup corresponding pointers to those data buckets and prim counts. This is meant simply as an example, and other ways of identifying which data buckets contain a designated prim attribute (e.g., reading and matching attribute labels from the prim buckets) and/or how many prims they store (e.g., looking up counts stored in the prim buckets) may be implemented within the scope of the present disclosure.

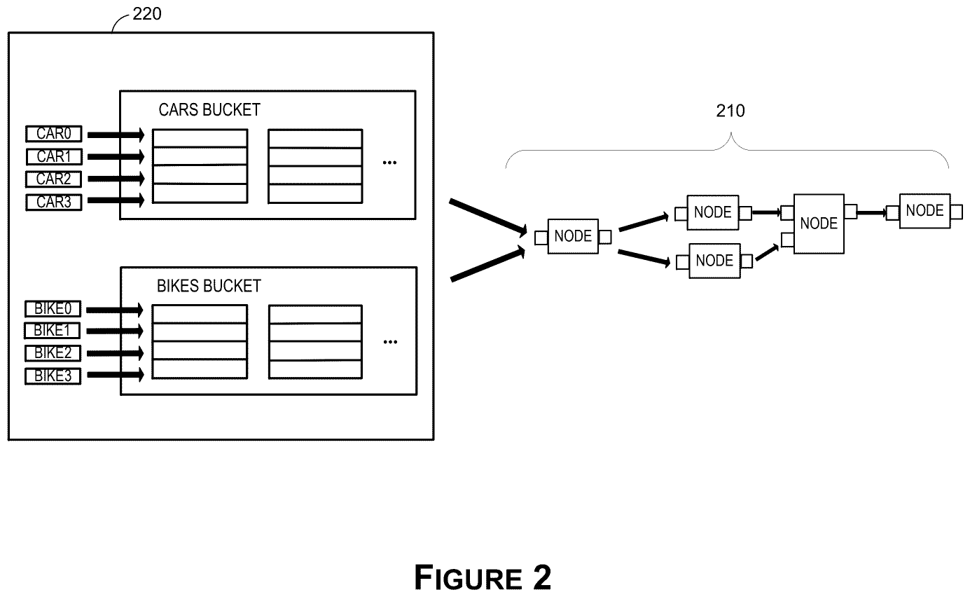

FIG. 2 illustrates an example compute graph 210 and corresponding target prims 220. In this example, the primitives include four cars stored according to SoA in a cars bucket and four bikes stored according to SoA in a bikes bucket, where the rows illustrated in the cars and bikes bucket represent the different primitives, and the columns represent different prim attributes (e.g., position, rotation, scale, color, weight, material, current speed, etc.). Note the prim attributes in a given bucket may differ for different types of prims and/or different data buckets (e.g., the car primitives might have an attribute storing current gas or battery level that the bike primitives do not have). In this example, the first node of the compute graph may designate a prim attribute that is common to the primitives in the cars and bikes buckets, so the query component 135 of FIG. 1 may query the prims 180 (e.g., as represented in a scene graph or prim manifest) to identify data buckets that store prims that have the designated prim attribute.

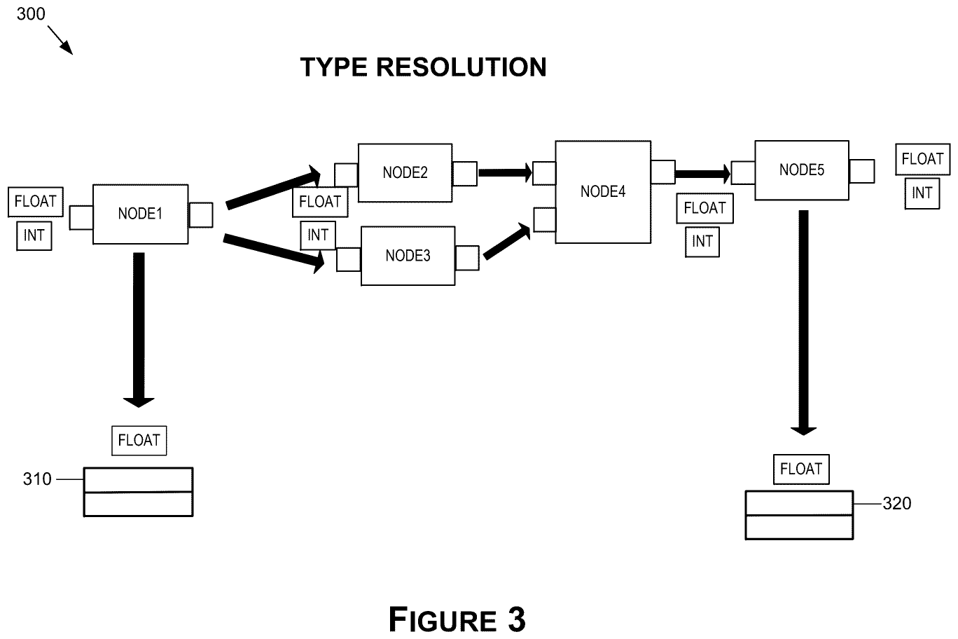

Returning to FIG. 1, the type resolution component 140 may resolve the data type for the chain of nodes in a compute graph. For example, FIG. 3 illustrates an example compute graph 300 with five nodes. In this example, each of these nodes may define a corresponding computation (e.g., multiplication) that can operate on integers or floating point numbers, and may output the same data type as its input data. However, the appliable data type for any given node may not be determined until the input data is determined. As such, in some embodiments, the query component 135 of FIG. 1 may identify the input data (e.g., target prims and/or their attribute data), and the type resolution component 140 may resolve the data type for each node in the compute graph 300, traversing the compute graph 300 and propagating the data type from node input to node output (e.g., based on the computation defined by the node) and from node to connected node until the data type for the entire the compute graph 300 has been resolved.

For example, if the target prim attribute data for the input to NODE1 (illustrated by row 310) is a float, the type resolution component 140 of FIG. 1 may lookup or otherwise determine the data type of the target prim attribute data 310 (e.g., from a scene graph or prim manifest, from the data bucket storing the data, from the data itself), resolve the input and output of NODE1 to a corresponding data type, determine that the output of NODE1 is connected to NODE2 and NODE3, resolve the inputs and outputs of those nodes to a corresponding data type, and so on. As such, the type resolution component 140 may propagate the type resolution through the compute graph 300 until the data type for all the node inputs and outputs (e.g., through the output of NODE5, illustrated by row 320) are resolved. This is meant simply as an example, and other node and data types are possible. For example, a given node may define an operation that takes in one type of data as input and outputs a different type of data (e.g., taking a string input, parsing a number from the string, and outputting an integer or float). Furthermore, a given node may take in multiple inputs that have different data types, and may define an operation that uses the input data to generate a corresponding output data type, or multiple outputs data types.

Returning now to FIG. 1, the memory allocation component 145 may allocate memory in the data store(s) 170 for (e.g., one or more instances of) the compute graph to accommodate the target prims identified by the query. Taking a compute graph that operates on a single prim as an example, the type resolution component 140 may resolve the data type for the nodes in the graph based on the data type of the target prim attribute of the prim, and the memory allocation component 145 may calculate an amount of contiguous memory that can store the type of data generated by each node (e.g., except for nodes that write data) and/or that can store the executable graph code and allocate (e.g., a graph data bucket with) that amount of memory in the data store(s) 170.

In some embodiments, a compute graph may be associated with (e.g., configured to operate on) many target prims. However, all the target prims may not be stored in the same data bucket in the data store(s) 170, and may instead be distributed across any number of data buckets. As such, in some embodiments, the memory allocation component 145 may allocate a single graph data bucket for multiple instances of the compute graph, and the memory allocation component 145 and/or the node execution component 150 may map the different input (and/or output) data buckets to corresponding positions in the graph data bucket.

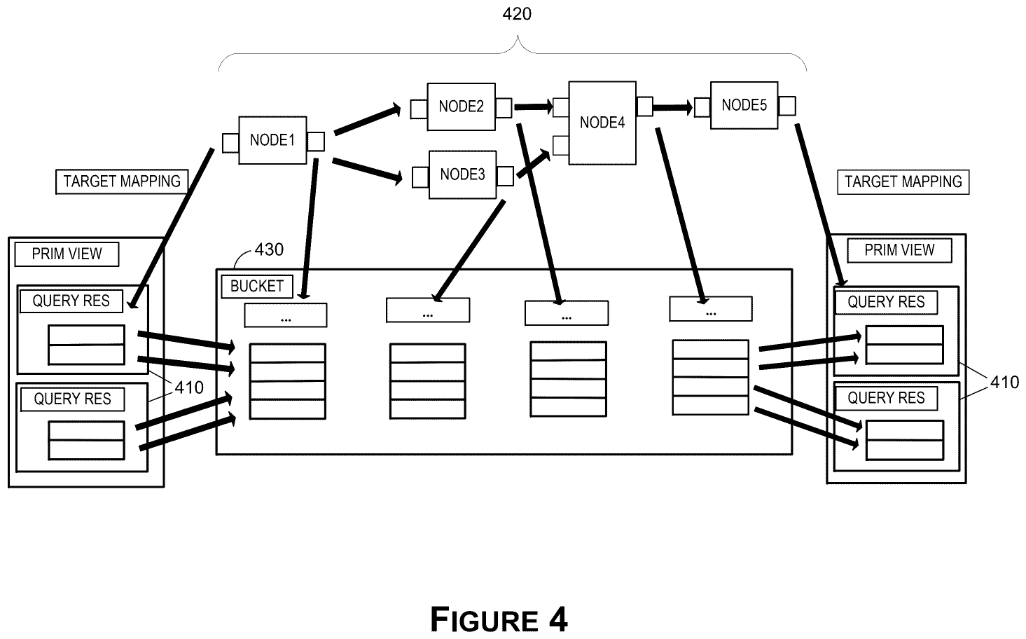

For example, FIG. 4 illustrates an example mapping between input data buckets 410 for a compute graph 420 and a corresponding graph bucket 430, in accordance with some embodiments of the present disclosure. In this example, NODE1 defines a target mapping (e.g., by specifying a target prim attribute in a corresponding node attribute that identifies the input data for the node), which may be used (e.g., by the query component 135 of FIG. 1) to identify the two input data buckets 410 that store the target prim attribute data for the target prims (illustrated as separate sets of query results in a prim view corresponding to the query). In this example, each entry in the input data buckets 410 (illustrated as a different rows or lines) represents the attribute data for a different prim, each entry in the input data buckets 410 is mapped to a corresponding entry in the graph bucket 430, each entry (illustrated as different rows or lines) in the graph bucket 430 represents allocated memory for a corresponding instance of the compute graph 420, and each column in the graph bucket 430 represents allocated memory for a corresponding node attribute(s) of the compute graph 420. Note that the output of one node and the input of another node may be aliased to the same column in the graph bucket.

As such, and returning to FIG. 1, the node execution component 150 may execute the compute graph using the allocated graph bucket (e.g., storing and/or executing the compute graph in the allocated graph bucket, storing computational results in the allocated graph bucket), reading the target prim attribute data from the identified data buckets, computing and writing the results of successive node operations in the graph bucket (e.g., using vectorized compute operations), and writing the results of a corresponding output node operation back to the identified data buckets. The node execution component 150 may execute independent nodes and/or independent instances of the compute graph in parallel.

By way of nonlimiting example and returning to FIG. 4, to execute NODE1, the node execution component 150 use references to the input data buckets 410 and/or corresponding target prim attribute data (e.g., identified by the query component 135) to read the target prim attribute data from corresponding locations of the input data buckets 410, execute the operation defined by NODE1 on the target prim attribute data without copying the target prim attribute data to the graph bucket 430, and write the results of the computation to the graph bucket 430. The node execution component 150 may continue executing the node operations (e.g., executing an instance of the compute graph corresponding to each row of the graph bucket 430 in parallel), writing the corresponding computational results to the graph bucket 430, passing computational results to successive nodes, and writing the computational results of NODE 5 back to the input data buckets 410. In some embodiments, the node execution component 150 may write the computational results of NODE5 back to the input data buckets 410 without first writing those computational results to the graph bucket 430.

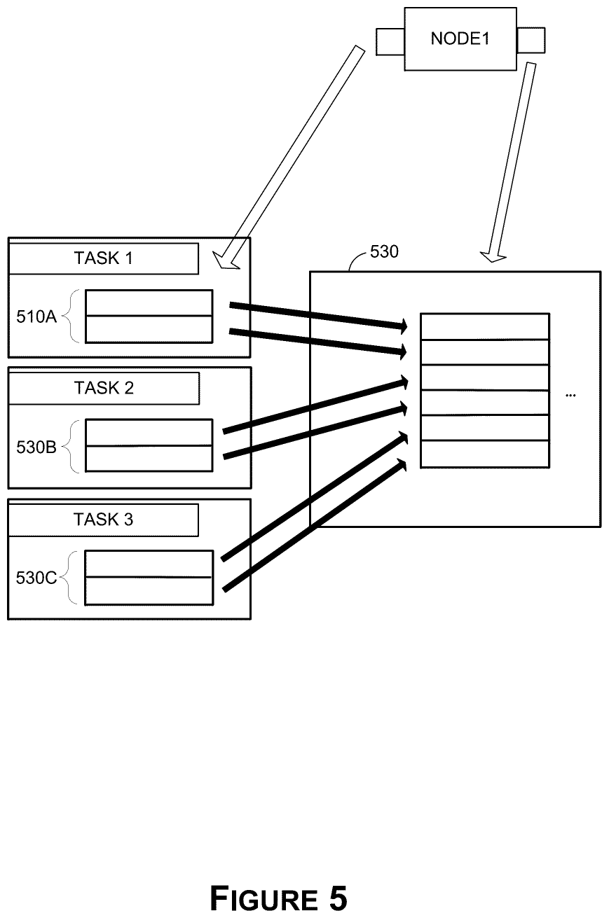

In some embodiments, since an input and/or an output node may map to different data buckets, the node execution component 150 may execute the input and/or output node using different tasks for the different data buckets. For example, FIG. 5 illustrates an example technique for executing an input graph node (NODE1) using different tasks for different target prim data buckets 510A, 510B, and 510C. In this example, NODE1 is associated with target prims that are spread out over three different target prim data buckets 510A, 510B, and 510C. As such, the node execution component 150 of FIG. 1 may execute code implementing the operation represented by NODE1 using the prim attribute data in the target prim data buckets 510A, 510B, and 510C in three different tasks. For example, the node execution component 150 may execute the computation defined by NODE1 using vectorized computations on the three different data buckets. By way of nonlimiting example, if NODE1 defines a scaling operation, task 1 may execute the scaling operation on all cubes, task 2 may execute the scaling operation on all cones, and task 3 may execute the scaling operation on all spheres. This process effectively consolidates and organizes the data into the graph bucket 530 into an order corresponding to the ordering of the prim attribute data in the target prim data buckets 510A, 510B, and 510C without copying the prim attribute data into the graph bucket 530 (as opposed to prior techniques that copy the prim data into the graph bucket in a random order).

As such, and returning to FIG. 1, the node execution component 150 may execute the nodes of one or more compute graphs, reading the target prim data from the prims 180 in the data store(s) 170, transforming the target prim data according to the operations defined by the compute graph(s), and writing the transformed prim data back to the prims 180. In some embodiments, the node execution component 150 may read and process the target prim data and/or and write the updated prim data using vectorized computations (e.g., using corresponding tasks for each input and/or output target prim data bucket). For example, assume an input node specifies multiplying two float arrays of count 16 each. The query may return a pointer(s) to the first float array and a pointer(s) to the second float array, so the node execution component 150 may use these pointers to read the referenced data and perform 16 multiplications at once, writing the results directly to allocated memory, vectorizing the results in a single buffer. As such, successive node operations may be executed using vectorized operations, and the resulting data may remain fully vectorized while travelling through the compute graph during the graph computations.

In some embodiments, an update component 155 may monitor for updates to the scene and/or compute graph, and may trigger a memory reallocation when a change is detected. For example, the update component 155 may periodically trigger the query component 135 (e.g., at a designated frame rate) to rerun the query, refreshing the references (e.g., pointers) to the target prims so the correct pointers are available (e.g., for each frame). In some embodiments, the update component 155 may compare the count of matching prims (e.g., in each matching data bucket) returned by an updated query with a corresponding count returned by baseline query results associated with the current memory allocation. Additionally or alternatively, the update component 155 may determine whether the compute graph has been modified and/or may (e.g., trigger the type resolution component 140 to) determine whether any of the data types specified by the compute graph have changed. If the update component 155 determines that the query results or the compute graph have changed, the update component 155 may trigger the type resolution component 140 and/or the memory allocation component 145 to reallocate memory based on the updated query results and/or compute graph. As such, if the scene gets updated and the number of matching prims changes, the update component 155 may automatically detect the change and optimize the graph bucket (e.g., by resizing the depth of the graph bucket) according to updated target prim data.

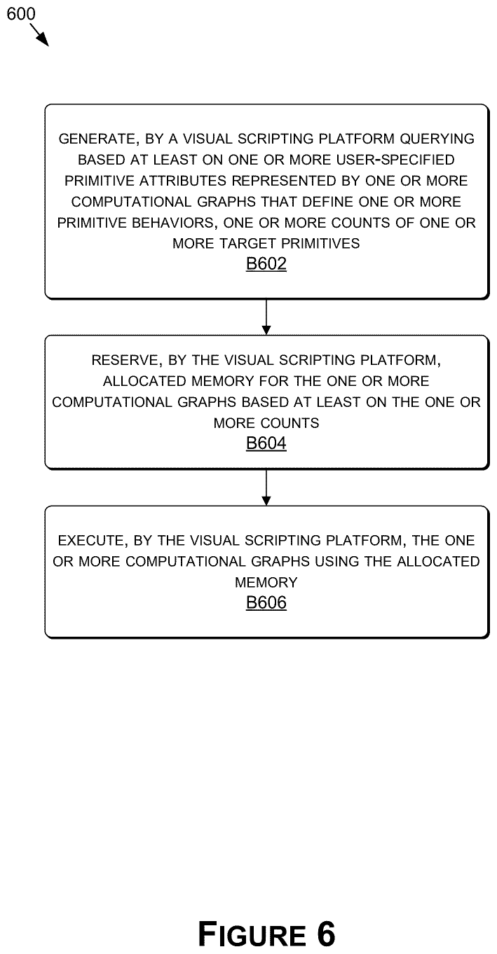

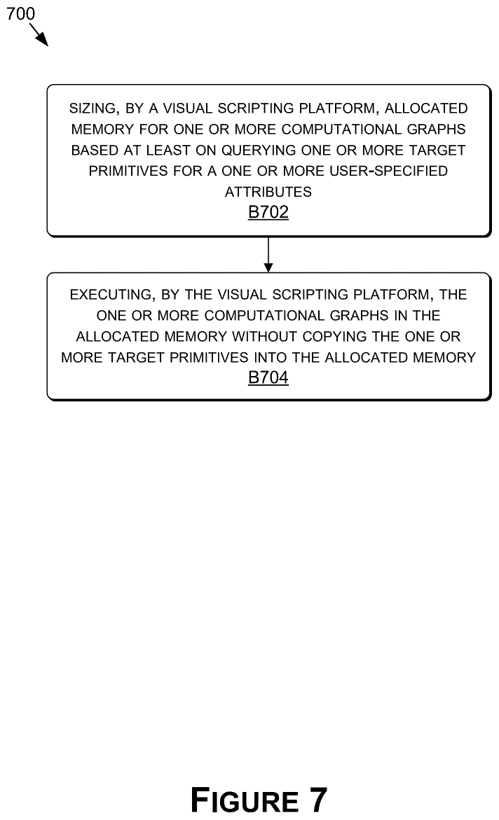

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a standalone service, a hosted service (standalone or in combination with another hosted service), or a plug-in to another product, to name a few. In addition, the methods 600 and 700 are described, by way of example, with respect to the visual scripting system 100 of FIG. 1. However, these methods may additionally or alternatively be executed by any one system, or any combination of systems, including, but not limited to, those described herein.

FIG. 6 is a flow diagram illustrating a method 600 for reserving memory for one or more computational graphs, in accordance with some embodiments of the present disclosure. The method 600, at block B602, includes generating, by a visual scripting platform querying based at least on one or more user-specified primitive attributes represented by one or more computational graphs that define one or more primitive behaviors, one or more counts of one or more target primitives. For example, with respect to the visual scripting system 100 of FIG. 1, the query component 135 may identify the target prims and/or prim attribute data for a designated compute graph by querying the prims 180 (e.g., as represented in a scene graph or prim manifest, by reading and matching attribute labels from prim buckets, etc.) for a target prim attribute designated by the compute graph, and may lookup corresponding pointers to those data buckets and prim counts (or may otherwise identify locations of the data buckets and/or generate or trigger a count of query search results).

The method 600, at block B604, includes reserving, by the visual scripting platform, allocated memory for the one or more computational graphs based at least on the one or more counts. For example, with respect to the visual scripting system 100 of FIG. 1, the type resolution component 140 may resolve the data type for the nodes in the graph based on the data type of the target prim attribute of the prim, and the memory allocation component 145 may calculate an amount of contiguous memory that can store the type of data generated by each node (e.g., except for nodes that write data) and/or that can store the executable graph code and allocate (e.g., a graph data bucket with) that amount of memory in the data store(s) 170.

The method 600, at block B605, includes executing, by the visual scripting platform, the one or more computational graphs using the allocated memory. For example, with respect to the visual scripting system 100 of FIG. 1, the node execution component 150 may execute the compute graph using the allocated graph bucket, reading the target prim attribute data from the identified data buckets, computing and writing the results of successive node operations in the graph bucket (e.g., using vectorized compute operations), and writing the results of a corresponding output node operation back to the identified data buckets.

FIG. 7 is a flow diagram illustrating a method 700 for sizing allocated memory for one or more computational graphs, in accordance with some embodiments of the present disclosure. The method 700, at block B702, includes sizing, by a visual scripting platform, allocated memory for one or more computational graphs based at least on querying one or more target primitives for one or more user-specified attributes. For example, with respect to the visual scripting system 100 of FIG. 1, the query component 135 may identify the target prims and/or prim attribute data for a designated compute graph by querying the prims 180 for a target prim attribute designated by the compute graph, and the memory allocation component 145 may allocate memory in the data store(s) 170 for (e.g., one or more instances of) the compute graph to accommodate the target prims identified by the query.

The method 700, at block B704, includes executing, by the visual scripting platform, the one or more computational graphs in the allocated memory without copying the one or more target primitives into the allocated memory. For example, with respect to the visual scripting system 100 of FIG. 1, the node execution component 150 may execute the compute graph using an allocated graph bucket, reading the target prim attribute data from the identified data buckets without copying the target prim attribute data into the graph bucket, computing and writing the results of successive node operations in the graph bucket (e.g., using vectorized compute operations), and writing the results of a corresponding output node operation back to the identified data buckets without writing the results in the graph bucket.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment-and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to determine one or more counts of one or more nodes corresponding to one or more target attributes, the one or more nodes being arranged in one or more computational graphs that define one or more behaviors of one or more primitives in a scene.

Clause 2. The one or more processors of clause 1, wherein the processing circuitry is further to reserve allocated memory for the one or more computational graphs based at least on the one or more counts.

Clause 3. The one or more processors of clause 1 or 2, wherein the processing circuitry is further to perform one or more scripting operations to produce a graphical representation of at least a portion of the scene by executing the one or more computational graphs using the allocated memory.

Clause 4. The one or more processors of clause 1, 2 or 3, wherein the one or more target attributes correspond to one or more identifiers in the one or more nodes of at least one of the computational graphs, the one or more nodes defining one or more transformations of target data.

Clause 5. The one or more processors of clause 1, 2 or 3, wherein the one or more target attributes identify one or more target primitives in the one or more computational graphs.

Clause 6. The one or more processors of clause 1, 2 or 3, wherein executing the one or more computational graphs is based at least on reading the one or more primitives without copying the one or more primitives into the allocated memory for the one or more computational graphs.

Clause 7. The one or more processors of clause 1, 2 or 3, wherein executing the one or more computational graphs is based at least on overwriting primitive data of the one or more primitives with updated primitive data without copying the updated primitive data from the allocated memory for the one or more computational graphs.

Clause 8. The one or more processors of clause 1, 2 or 3, wherein the processing circuitry is further to arrange the one or more computational graphs in one or more first data groupings in the allocated memory based at least on an arrangement of target primitive data of the one or more target primitives in one or more second data groupings at least partially stored using memory that is not the allocated memory.

Clause 9. The one or more processors of clause 1, 2 or 3, wherein the processing circuitry is further to execute a type resolution based at least on propagating one or more data types through the one or more computational graphs, and to reserve the allocated memory for the one or more computational graphs based at least on the type resolution.

Clause 10. The one or more processors of clause 1, 2 or 3, wherein the one or more target attributes are defined by a query, the query comprising a periodic query, and the processing circuitry is further to update the allocated memory based at least on updated results responsive to the updated query.

Clause 11. The one or more processors of clause 1, 2 or 3, wherein the processing circuitry is comprised in at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for generating synthetic data; a system for performing one or more generative AI operations; a system that implements one or more large language models (LLMs); a system that implements one or more vision language models (VLMs); a system incorporating one or more virtual machines (VMs); a system implemented at least partially in a data center; or a system implemented at least partially using cloud computing resources.

Clause 12. A system comprising one or more processors to perform one or more scripting operations by executing one or more computational graphs in allocated memory, the allocated memory being sized based at least on a count of components determined responsive to querying for one or more target primitives corresponding to one or more graph nodes of the one or more computational graphs.

Clause 13. The system of clause 12, wherein the querying is based at least on storing one or more identifiers of the components in the one or more graph nodes, the one or more graph nodes defining one or more transformations of target data stored in the components.

Clause 14. The system of clause 12 or 13, wherein the components identify the one or more target primitives in the one or more computational graphs.

Clause 15. The system of clause 12, wherein executing the one or more computational graphs is based at least on reading the one or more target primitives without copying the one or more target primitives into the allocated memory for the one or more computational graphs.

Clause 16. The system of clause 12, wherein executing the one or more computational graphs is based at least on overwriting target primitive data of the one or more target primitives with updated target primitive data without copying the updated target primitive data from the allocated memory for the one or more computational graphs.

Clause 17. The system of clause 12, wherein the one or more processors are further to arrange the one or more computational graphs in one or more first data groupings in the allocated memory based at least on an arrangement of target primitive data of the one or more target primitives in one or more second data groupings stored at least partially using memory that is not the allocated memory.

Clause 18. The system of clause 12, wherein the one or more processors are further to execute a type resolution based at least on propagating one or more data types through the one or more computational graphs, and reserve the allocated memory for the one or more computational graphs based at least on the type resolution.

Clause 19. The system of clause 12, wherein the querying the target primitives comprises periodically querying for one or more target primitives, and wherein the one or more processors are further to update the allocated memory based at least on a count of components determined responsive to the periodic querying.

Clause 20. The system of clause 12, wherein the system is comprised in at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for generating synthetic data; a system for performing one or more generative AI operations; a system that implements one or more large language models (LLMs); a system that implements one or more vision language models (VLMs); a system incorporating one or more virtual machines (VMs); a system implemented at least partially in a data center; or a system implemented at least partially using cloud computing resources.

Clause 21. A method comprising determining a size for an allocated memory for one or more computational graphs based at least on querying one or more target primitives for one or more user-specified attributes.

Clause 22. The method of clause 21, further comprising performing one or more scripting operations by executing the one or more computational graphs in the allocated memory without copying the one or more target primitives into the allocated memory.

Clause 23. The method of clause 21 or 22, wherein the method is performed by at least one of: a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for generating synthetic data; a system for performing one or more generative AI operations; a system that implements one or more large language models (LLMs); a system that implements one or more vision language models (VLMs); a system incorporating one or more virtual machines (VMs); a system implemented at least partially in a data center; or a system implemented at least partially using cloud computing resources.

What is claimed is:

1. One or more processors comprising processing circuitry to:
determine one or more counts of one or more nodes corresponding to one or more target attributes, the one or more nodes being arranged in one or more computational graphs that define one or more behaviors of one or more primitives in a scene;
reserve allocated memory for the one or more computational graphs based at least on the one or more counts; and
perform one or more scripting operations to produce a graphical representation of at least a portion of the scene by executing the one or more computational graphs using the allocated memory.

2. The one or more processors of claim 1, wherein the one or more target attributes correspond to one or more identifiers in the one or more nodes of at least one of the computational graphs, the one or more nodes defining one or more transformations of target data.

3. The one or more processors of claim 1, wherein the one or more target attributes identify one or more target primitives in the one or more computational graphs.

4. The one or more processors of claim 1, wherein executing the one or more computational graphs is based at least on reading the one or more primitives without copying the one or more primitives into the allocated memory for the one or more computational graphs.

5. The one or more processors of claim 1, wherein executing the one or more computational graphs is based at least on overwriting primitive data of the one or more primitives with updated primitive data without copying the updated primitive data from the allocated memory for the one or more computational graphs.

6. The one or more processors of claim 1, wherein the processing circuitry is further to arrange the one or more computational graphs in one or more first data groupings in the allocated memory based at least on an arrangement of target primitive data of the one or more target primitives in one or more second data groupings at least partially stored using memory that is not the allocated memory.

7. The one or more processors of claim 1, wherein the processing circuitry is further to execute a type resolution based at least on propagating one or more data types through the one or more computational graphs, and to reserve the allocated memory for the one or more computational graphs based at least on the type resolution.

8. The one or more processors of claim 1, wherein the one or more target attributes are defined by a query, the query comprising a periodic query, and the processing circuitry is further to update the allocated memory based at least on updated results responsive to the updated query.

9. The one or more processors of claim 1, wherein the processing circuitry is comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for performing one or more generative AI operations;
a system that implements one or more large language models (LLMs);
a system that implements one or more vision language models (VLMs);
a system incorporating one or more virtual machines (VMs);
a system implemented at least partially in a data center; or
a system implemented at least partially using cloud computing resources.

10. A system comprising one or more processors to perform one or more scripting operations by executing one or more computational graphs in allocated memory, the allocated memory being sized based at least on a count of components determined responsive to querying for one or more target primitives corresponding to one or more graph nodes of the one or more computational graphs.

11. The system of claim 10, wherein the querying is based at least on storing one or more identifiers of the components in the one or more graph nodes, the one or more graph nodes defining one or more transformations of target data stored in the components.

12. The system of claim 11, wherein the components identify the one or more target primitives in the one or more computational graphs.

13. The system of claim 10, wherein executing the one or more computational graphs is based at least on reading the one or more target primitives without copying the one or more target primitives into the allocated memory for the one or more computational graphs.

14. The system of claim 10, wherein executing the one or more computational graphs is based at least on overwriting target primitive data of the one or more target primitives with updated target primitive data without copying the updated target primitive data from the allocated memory for the one or more computational graphs.

15. The system of claim 10, wherein the one or more processors are further to arrange the one or more computational graphs in one or more first data groupings in the allocated memory based at least on an arrangement of target primitive data of the one or more target primitives in one or more second data groupings stored at least partially using memory that is not the allocated memory.

16. The system of claim 10, wherein the one or more processors are further to execute a type resolution based at least on propagating one or more data types through the one or more computational graphs, and reserve the allocated memory for the one or more computational graphs based at least on the type resolution.

17. The system of claim 10, wherein the querying the target primitives comprises periodically querying for one or more target primitives, and wherein the one or more processors are further to update the allocated memory based at least on a count of components determined responsive to the periodic querying.

18. The system of claim 10, wherein the system is comprised in at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for performing one or more generative AI operations;
a system that implements one or more large language models (LLMs);
a system that implements one or more vision language models (VLMs);
a system incorporating one or more virtual machines (VMs);
a system implemented at least partially in a data center; or
a system implemented at least partially using cloud computing resources.

19. A method comprising:
determining a size for an allocated memory for one or more computational graphs based at least on querying one or more target primitives for one or more user-specified attributes; and
performing one or more scripting operations by executing the one or more computational graphs in the allocated memory without copying the one or more target primitives into the allocated memory.

20. The method of claim 19, wherein the method is performed by at least one of:
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data;
a system for performing one or more generative AI operations;
a system that implements one or more large language models (LLMs);
a system that implements one or more vision language models (VLMs);
a system incorporating one or more virtual machines (VMs);
a system implemented at least partially in a data center; or
a system implemented at least partially using cloud computing resources.
